(19) United States
(12) Patent Application Publication
(10) Pub. No.: US 2005/0204829 A1
(43) Pub. Date: Sep. 22, 2005

(54) Fluid flow sensor assembly with high turndown ratio and low pressure drop

(76) Inventor: Jeffrey David Cohen, Kennett Square, PA (US)

Correspondence Address: Jeffrey D. Cohen, 6 Clover Lane, Kennett Square, PA, 19348, US

(21) Appl. No.: 11/081,585

(22) Filed: Mar. 17, 2005

Related U.S. Application Data
(60) Provisional application No. 60/554,944, filed on Mar. 22, 2004.

(51) Int. Cl. G01F 1/22

(52) U.S. Cl. 73/861.53

(57) ABSTRACT

A fluid flow sensor assembly comprised of a fluid flow sensor plumbed to convey flow in parallel with a normally-closed, high-flow valve, displaceable to an opened position in response to hydrodynamic force, for placement into a fluid conduit to achieve a precise measurement of the fluid volumetric flow with a high turndown ratio at a pressure drop below which the flow sensor alone would impose, is disclosed. In addition, the mathematic relationship of the flow sensor output to the fluid volumetric flow rate through the parallel flow sensor assembly, throughout the flow range, is disclosed.

### BACKGROUND OF TH INVENTION

The use of flow sensors for measuring the fluid volumetric flow in closed conduits is well known. Typical flow sensors include U.S. Pat. No. 4,404,860 issued to Wood et al., 4,936,151 issued to Tokio and 4,656,873 issued to Stewart. These sensors utilize various methods for converting various phenomena associated with the dynamics of fluid flow into conveniently measured analogs thereof. These analogs, by calibration, can be used to measure the rate of the fluid volumetric flow. One major method of measuring fluid volumetric flow is to determine the rotational frequency of rotary devices driven by the fluid; utilizing electromechanical means to determine that rotational frequency, as an analog of the fluid volumetric flow. Conventional flow sensors of this type used in determining flow rate are characterized by a turndown ratio. This ratio is defined as a measure of the dynamic range of response of a given sensor over which the accuracy of the sensor output, referred to as the average actual flow rate in the pipe, is within specified limits. Typical flow sensors of the impeller type have turndown ratios of 10:1 to 40:1. For example, if a flow sensor is able to measure fluid volumetric flow rate ranging from 1 gallon per minute to 25 gallons per minute, then its turndown ratio is 25:1. The flow rate of the fluid is linearly proportional to the rate of rotation of the above mentioned electromechanical means such as an impeller within this range.

Having a low turndown ratio does not provide the necessary versatility to a flow sensor. A low ratio results from the inability of a flow sensor to measure flow rate that is substantially higher or substantially lower than the normal or average flow rate. A flow sensor with a low turndown ratio would appear to measure these flow rates but the accuracy of these readings would be suspect.

In addition, flow sensors capable of accurately measuring low volumetric flow rates impose a large pressure drop, when conveying fluid at a high volumetric flow rate, by subtracting energy through friction opposing fluid flow, thus physically restricting the maximum achievable volumetric flow rate and limiting the availability of fluid downstream.

Flow sensor assemblies that utilize a flow switch arranged in parallel with a normally-closed valve, displaceable to an opened position in response to sufficient hydrodynamic force are well known. Typical flow sensors include U.S. Pat. No. 5,503,175 issued to Ravilious, et. al. and 6,105,607 issued to Caise, et al. These sensors respond to the absence, or presence, of flow by transmitting an off, or on, signal respectively. They do not, however, disclose a practical method of obtaining information about quantified flow rates, i.e., volume per time such as liters per second or gallons per minute.

A flow sensor assembly comprised of a volumetric flow sensor arranged in parallel with a normally-closed valve, automatically displaceable to an opened position in response to sufficient hydrodynamic force, will transmit an output signal in relation to the flow rate that passes through the flow sensor assembly; however, the output signal-to-flow rate relationship throughout the range of volumetric flow rates will be nonlinear. Therefore, for the output signal to be useful in sensing volumetric flow rate, a mathematic or calibration relationship between the volumetric flow sensor output signal and the volumetric flow rate must be determined.

### SUMMARY OF THE INVENTION

An object of this invention is to provide a fluid flow sensor assembly for monitoring flow through a conduit, wherein the fluid flow sensor assembly is comprised of a fluid flow sensor operating in parallel with a normally-closed, high-flow valve displaceable to an opened position in response to hydrodynamic force.

A further object of this invention is to provide such an assembly which accurately senses fluid flow rates, i.e., volume per time, through the flow conduit over a large range of flow rates, beyond which the flow sensor alone would measure, when operating at the same pressure drop.

A further object of this invention is to provide such an assembly which accurately senses fluid flow rates through the flow conduit over a large range of flow rates by, at low flow rates, conveying flow through only the flow sensor portion of the flow sensor assembly, and at increased flow rates, conveying concurrent, parallel flow through both the flow sensor and the normally-closed, high-flow valve portions of the flow sensor assembly.

A further object of this invention is to provide a relationship, for example a mathematic relationship or a calibration relationship, which describes the volumetric flow rate that passes through the flow sensor assembly, as a function of the transmitted flow sensor output signal and the flow characteristics of fluid flow through the flow sensor assembly throughout the range of fluid flow rates. Such a relationship will provide a useful algorithm for monitoring and/or controlling fluid flow through conduits such as, for example, pipes. Furthermore such a relationship will eliminate the need to individually calibrate flow sensor assemblies constructed as duplicate copies of the original design.

What is desired, therefore, is a flow sensor assembly capable of sensing volumetric flow rates over a wide range of flow rates while offering a low pressure drop across the flow sensor assembly.

In accordance with this invention a volumetric fluid flow sensor assembly is provided which includes a flow sensing means operating in parallel with a normally-closed, high-flow valve, displaceable to an opened position in response to hydrodynamic force, mounted to a pipe through which the fluid flows under high pressure to sense the flow of fluid through the pipe.

A flow sensor assembly of the present invention comprises a flow sensor which outputs a signal in relation to fluid flow rate moving through the flow sensor; and a normally-closed, high-flow valve which conveys concurrent, proportional, parallel fluid flow at pressure drops across the normally-closed valve sufficient to automatically open the normally-closed valve.

Furthermore, in accordance with this invention, a mathematic relationship is provided that relates the output signal of a volumetric fluid flow sensor, in the above mentioned fluid flow sensor assembly, to the fluid flow rate that passes through the flow sensor assembly, throughout the range of fluid flow rates.

Furthermore, in accordance with this invention, a calibration relationship is provided that relates the output of a volumetric fluid flow sensor, in the above mentioned fluid flow sensor assembly, to the fluid flow rate that passes through the flow sensor assembly, throughout the range of fluid flow rates.

### BRIEF DESCRIPTION OF THE DRAWINGS

These and other objects, features and advantages of the present invention will be readily apparent to one skilled in the art from the following written description, read in conjunction with the drawings, in which:

FIG. 1 is a cross-sectional view of a flow sensor assembly comprised of a flow sensor operating in parallel with a normally-closed, high-flow valve operating at a low volumetric flow rate, according to an embodiment of the present invention;

FIG. 2 is a cross-sectional view of a flow sensor assembly comprised of a flow sensor operating in parallel with a normally-closed, high-flow valve, displaceable to an opened position in response to hydrodynamic force, operating at a high volumetric flow rate, according to an embodiment of the present invention;

FIG. 3 is a plot of the flow sensor output frequency as a function of the fluid volumetric flow rate through the flow sensor assembly.

### DETAILED DESCRIPTION

The flow sensor assembly of the present invention is to be employed in fluid applications provided the materials of construction are compatible with the fluids conveyed.

The flow sensor assembly of the present invention is to be employed primarily in aqueous applications. The aqueous applications range from bases with a high pH level to acids having a low pH level. Operating temperature for the flow sensor assembly ranges from above the freezing point of the fluid in the conduit to below the boiling point of the fluid in the conduit based on the fluid composition and the absolute pressure of the system. The maximum operating pressure of the flow sensor assembly is limited by the materials of construction and the dimensions of those materials, i.e., conduit inner dimensions, wall thickness, and means of fastening together the components, e.g. connections threaded, flanged, or cemented with solvent-based polymer. Prototype versions of the flow sensor assembly have operated successfully in pipes having a diameter of 0.50 inch to 2 inches. Extension to larger pipe diameters is expected to be relatively simple. In order to facilitate this range, the flow sensor assembly of the present invention requires calibration for each specific pipe diameter.

The flow sensor assembly of the present invention comprises a flow sensor operating in parallel with a normally-closed valve displaceable to an opened position in response to hydrodynamic force. At low fluid flow rates the normally-closed valve remains closed due to the low pressure drop across the flow sensor assembly. The low fluid flow rate and the attendant low pressure drop across the flow sensor assembly are insufficient to force open the normally-closed valve. At low fluid flow rates, therefore, all of the fluid flow is conveyed through only the fluid flow sensor portion of the flow sensor assembly. Thus, the minimum measurable fluid flow rate is determined by the dynamic characteristics of the fluid flow sensor portion of the flow sensor assembly.

The flow sensor of the present invention is of the type intended to measure the volumetric flow rate of fluid. The flow sensor outputs a signal in proportion to the volumetric flow rate of fluid that passes through it; and therefore, it is distinguished from a flow switch that outputs an off, or on, signal in response to the absence, or presence, of fluid flow respectively. The flow sensor includes an impeller having a low mass and low diameter. As a result, the size of the sensor can be minimal. There are several advantages to having a small sensor. Its size leads to less intrusion in the flow stream. The small size and the shape of the impeller minimize its resistance to flow, extend the lower limit of the flow rate range, and minimize the rotary inertia of the rotating parts. Smaller size also results in simplicity of installation. Given the small size of the impeller blades, there is a reduced sensor area that is exposed to the fluid. A reduced wetted area of the sensor results in lower hydrodynamic forces that tend to displace the sensor from the pipe or other fluid conduit in which it is installed. Given its size, its construction involves few materials. The cost of the sensor is also low because few expensive materials need to be used for its construction.

Normally-closed valves which open in response to a hydrodynamic force, in the form of check valves, are typically used in piping systems to permit fluid flow in only one direction, thus preventing undesired back flow of fluid upstream. The magnitude of hydrodynamic force, i.e., the cracking pressure (P_{cracking}), required to open normally-closed valves of this type is dependent upon the opposing force which seats the valve closure. This opposing force may be provided, for example, by gravity, or by a spring which enables the valve closure to function in any orientation relative to the direction of gravitational force.

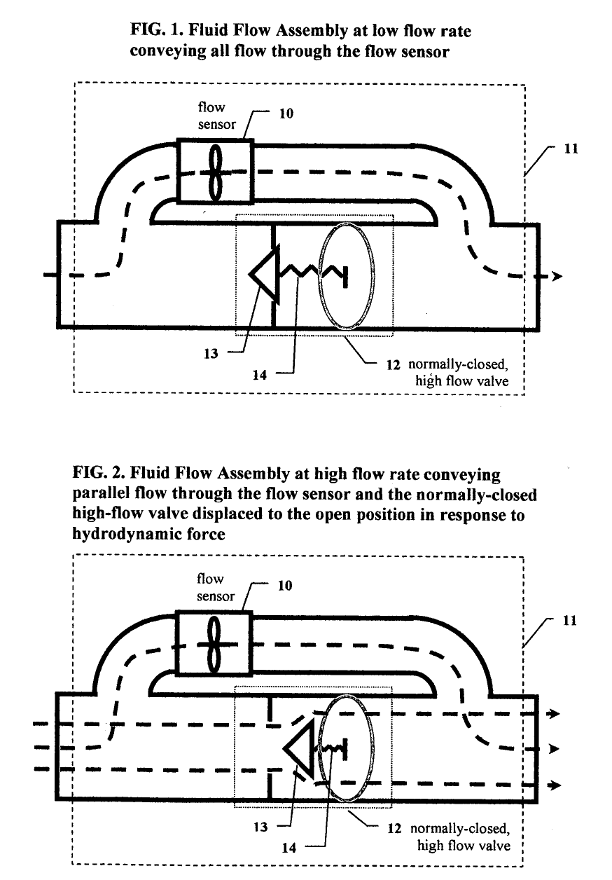

In the present invention the normally-closed, check valve serves the following purposes:
1. At low fluid flow rates the normally-closed, check valve remains closed thus directing all fluid flow through the flow sensor plumbed in parallel with the normally-closed, check valve, thereby ensuring the sensing of flow at low flow rates, FIG. 1 and;
2. at higher flow rates, i.e., at fluid flow rates sufficient to force flow through the normally-closed, check valve, the selected normally-closed, check valve has internal dimensions exceeding those of the flow sensor, thus, when open, the normally-closed, check valve conveys fluid volumetric flow proportional to, and when sufficiently open, in excess of the concurrent parallel volumetric flow through the flow sensor, FIG. 2.

The normally-closed, high-flow valve, which operates to convey fluid flow in parallel with the flow sensor, thus amplifies the maximum volumetric flow rate of the flow sensor assembly, for a given pressure drop across the assembly, versus the maximum fluid volumetric flow rate that would pass through the flow sensor alone. Thus the flow sensor assembly has a higher turndown ratio, for a given pressure drop, versus the turndown ratio of the flow sensor alone.

It is advantageous to specify a normally-closed, high-flow valve having a Flow Coefficient (Cv) equal to, or higher, than the Cv of the flow sensor. This provides for a flow sensor assembly operational at a pressure drop below that of the flow sensor alone for a given fluid volumetric flow rate. Perry's Handbook of Chemical Engineering 7th Edition, defines the Flow Coefficient (Cv) as the proportionality factor relating the fluid volumetric flow through a conduit, in units of gallons per minute (GPM), to the square root of the pressure drop required to produce the volumetric flow, in units of pounds force per square inch (psi), as written in Equation 1:
GPM=Cv(Δpsi)^{1/2} Equation 1
The Cv is the number of gallons per minute of 60° F. water that will flow through a defined conduit at a 1 psi pressure drop across the defined conduit.

In the reduction to practice of the present invention, the flow sensing assembly components, i.e., a fluid flow sensor and a normally-closed, high-flow check valve, are clearly visible as separate components comprising the final assembly, as seen in FIG. 1. It is possible to combine together both the flow sensor and the normally-closed, high flow valve functions into a single apparatus suitable for placement into a fluid conduit to achieve the fluid flow sensor function with high turndown ratio at a pressure drop below which the flow sensor alone would impose.

A calibration is required to relate the fluid volumetric flow rate, through the flow sensor assembly, to the flow sensor signal output, over the range of anticipated fluid volumetric flow rate. The calibration data may then be used to determine the hydrodynamic parameters of the flow sensor assembly such as the flow coefficients of the parallel flow paths and the cracking pressure of the normally-closed, valve closure. The hydrodynamic parameters may then be used to create a mathematic relationship of the flow sensor output to the fluid volumetric flow rate. The mathematic relationship of flow sensor output to the volumetric flow rate which passes through the flow sensor assembly, throughout the flow range, may be used as the basis for an algorithm for flow rate monitoring and/or flow control.

In order to promote a complete understanding of the present invention, elements of the flow sensor will be described with respect to the figures.

The flow sensor 10 of FIG. 1, as installed in the fluid flow sensor assembly 11, is generally composed of a turbine, or paddle wheel, type impeller, an impeller housing, and a magnetic, inductive, capacitance, infrared, or optical sensor capable of detecting rotary motion of the impeller as fluid flows within the pipe.

The normally-closed, high-flow valve 12 of the present invention is a valve which conveys fluid flow in only one direction due to the presence of an internal closure 13, held normally-closed using a spring 14 which, upon application of sufficient hydrodynamic force, may be opened to convey flow in that same direction. The internal dimensions of the normally-closed, high-flow valve 12 provide for maximum fluid volumetric flow rates conveyed through the normally-closed valve, when displaced to an opened position, that may greatly exceed the maximum fluid volumetric flow rates capable of moving through the flow sensor 10 portion alone.

The case of low fluid volumetric flow is illustrated in FIG. 1 in which the normally-closed, high flow valve 12 remains closed and all fluid flow is directed through the flow sensor 10.

The case of high fluid volumetric flow is illustrated in FIG. 2 in which the normally-closed, high flow valve 12 is forced open, due to the increased pressure drop across the flow sensor assembly associated with high volumetric fluid flow, which results in parallel fluid volumetric flow through both the flow sensor 10 and the normally-closed, high flow valve 12, displaced to an opened position. At this pressure drop, which equals or exceeds the cracking pressure of the valve closure, the total fluid volumetric flow exceeds that which the flow sensor 10 alone conveys. Thus an amplification of fluid volumetric flow is achieved, for a given pressure drop, concurrent with the signal transmission of flow information from the flow sensor 10.

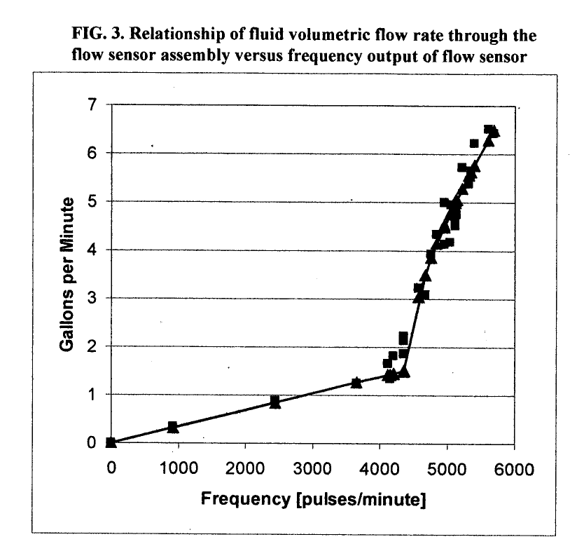

A plot of the relationship of fluid volumetric flow to flow sensor 10 output frequency is illustrated FIG. 3. This relationship provides the calibration information necessary to employ the flow sensor 10 signal for fluid volumetric flow rate measurement using the fluid flow sensor assembly 11.

### EXAMPLE 1

A fluid flow sensing assembly 11 was constructed comprised of a Parker/UCC International Corporation, Dataflow Compact Flow Sensor 10, Model DFC.900.100 and a polyvinyl chloride (PVC), 0.75 inch, Schedule 40, American Valve, Inc., Milano, Normally-Closed, Check Valve 12, Model P32S—0.75 inch. The normally-closed, check valve 12 was designed to commence conveying fluid flow in only one direction when a specific pressure drop across the valve, i.e., a cracking pressure, of 0.5 pounds per square inch (psi), was exceeded. Using PVC plumbing fittings, produced by Lasco Fittings, Inc., the flow sensor and the normally-closed, check valve were plumbed in a parallel flow arrangement as seen in FIG. 1.

The Fluid Flow Sensing Assembly was installed in series with a residential, piped water system capable of conveying water flow under pressure throughout the building. The electrical output of the Dataflow Compact Flow Sensor 10, was received and reported by a MicroLab Engineering, Inc., Lab-X1 single board computer containing a MicroChip, Inc., PIC 16F877 Microcontroller, programmed to receive and report the frequency output of the flow sensor 10 and compute the fluid volumetric flow rate in gallons per minute.

At zero fluid flow the flow sensor 10 electrical frequency output was 0 Hertz (Hz).

At low fluid flow rates, i.e., >0 to 1.5 gallons per minute (GPM), all of the fluid flow was conveyed through the flow sensor 10, i.e., fluid flow rates capable of flowing through the fluid flow sensor assembly 11 at less than or equal to the cracking pressure of the normally-closed, check valve 12. The flow sensor 10 electrical frequency output ranged from >0 Hz to 72 Hz, i.e., >0 to 4320 pulses per minute (ppm) in relation to the fluid volumetric flow rate measured in GPM.

At flow rates above 1.5 gallons per minute, the pressure drop across the fluid flow sensing assembly 11 equaled, or exceeded, the cracking pressure of the normally-closed, high-flow, check valve 12 and fluid flow commenced through both the fluid flow sensor 10 portion of the fluid flow sensing assembly 11 and the 0.75 inch, normally-closed, high-flow, check valve 12 portion of the fluid flow sensing assembly 11, FIG. 2. At high flow rates, sufficient to convey flow through both the flow sensor 10 and the normally-closed, 0.75 inch check valve 12, it was determined that the ratio of the check valve Cv to the flow sensor Cv equaled 3.7. The flow sensor 10 electrical frequency output ranged from >72 Hz and above, i.e., >4320 ppm and above, in relation to the fluid volumetric flow rate measured in GPM, FIG. 3.

### EXAMPLE 2

A fluid flow sensing assembly was constructed as described in Example 1 with the exception that a 1.0 inch Normally-Closed, Check Valve 12, was used in place of the 0.75 inch, normally-closed, check valve used in Example 1, as seen in FIG. 1. The 1.0 inch Normally-Closed, Check Valve 12 was a Milano, Model P32S—1.0 inch, manufactured by, American Valve, Inc. The normally-closed, check valve 12 was designed to convey fluid flow in only one direction when a specific pressure drop across the valve, i.e., a cracking pressure, of 0.5 pounds per square inch (psi), was exceeded.

At zero fluid flow the flow sensor 10 frequency output was 0 Hertz (Hz).

At low fluid flow rates, i.e., 0 to 1.5 gallons per minute (GPM), all of the fluid flow was conveyed through the flow sensor 10, i.e., fluid flow rates capable of flowing through the fluid flow sensor assembly 11 at less than or equal to the cracking pressure of the normally-closed, check valve 12. The flow sensor 10 electrical frequency output ranged from >0 Hz to 72 Hz, i.e., >0 to 4320 ppm, FIG. 3, in relation to the fluid volumetric flow rate measured in GPM.

At flow rates above 1.5 gallons per minute, the pressure drop across the fluid flow sensing assembly 11 equaled, or exceeded, the cracking pressure of the normally-closed, high-flow, check valve 12 and fluid flow commenced through both the fluid flow sensor 10 portion of the fluid flow sensing assembly 11 and the 1.0 inch, normally-closed, high-flow, check valve 12 portion of the fluid flow sensing assembly 11. At high flow rates, sufficient to convey flow through both the flow sensor 10 and the normally-closed 1.0 inch, check valve 12, it was determined that the ratio of the check valve Cv to the flow sensor Cv equaled 5.5. The flow sensor 10 electrical frequency output ranged from >72 Hz and above, i.e., >4320 ppm and above, in relation to the fluid volumetric flow rate measured in GPM.

### EXAMPLE 3

A fluid flow sensing assembly 11 was constructed as described in Example 1. A second flow sensor was plumbed in series with the flow sensor assembly and used to measure the flow rate passing through the flow sensor assembly 11 through the full range of flow rates. The output signal of flow sensor 10 was related to the fluid flow rate passing through the flow sensor assembly 11 through the full range of flow rates. This provided calibration information which is plotted as frequency of flow sensor 10 versus volumetric flow rate that passed through the fluid flow sensor assembly 11 seen as square data points in FIG. 3. The fluid volumetric flow rate that passed through the fluid flow sensor assembly 11 was mathematically related to the signal output of flow sensor 10 by the following relationship, Equation 2:
pulses/volume=K-factor/(1+((Cv₂/Cv₁)²−((Cv₂)²(P_{cracking})(K-factor)²/(frequency output)²))^{0.5}) Equation 2
where:
pulses/volume is the number of pulses transmitted by the sensor 10 in response to the fluid volume that has passed through the flow sensor assembly 11,
K-factor is the number of pulses transmitted by the sensor 10 in response to the fluid volume that has passed through flow sensor 10,
Cv₁ is the flow coefficient of flow through the flow sensor 10 section of the flow sensor assembly,
Cv₂ is the flow coefficient of flow through the flow sensor assembly section containing a normally-closed valve 12 displaceable to an opened position in response to hydrodynamic force,
P_{cracking} is the pressure drop at which flow commences through the normally-closed, valve displaceable to an opened position, of the flow sensor assembly.
   This mathematic relationship, i.e. Equation 2, is seen as triangular data points and a solid line plotted in FIG. 3.

The present invention has been described in terms of specific embodiments to facilitate understanding. The above embodiments, however, are illustrative rather than restrictive. It will be readily apparent to one skilled in the art that departures may be made from the specific embodiments shown above without departing from the central spirit and scope of the invention. Therefore, the invention should not be regarded as being limited to the above examples, but should be regarded instead as being fully commensurate in scope with the following claims.

1. A fluid volumetric flow sensor assembly comprising:
a fluid flow sensor; and
a normally-closed valve displaceable to an opened position in response to hydrodynamic force,
plumbed in parallel to convey fluid flow,
for placement into a fluid conduit to achieve the fluid flow sensor function with;
a turndown ratio higher than the said fluid flow sensor alone would offer, and
at a pressure drop lower than the said fluid flow sensor alone would require.

2. The flow sensor assembly of claim 1 wherein the conduit is a pipe.

3. The flow sensor assembly of claim 1 used to measure fluid flow in a residential plumbing control system.

4. A method of extending the dynamic range of a fluid volumetric flow sensing device providing a measure of fluid volumetric flow based on a fluid flow sensor assembly comprising:
a fluid flow sensor; and
a normally-closed valve displaceable to an opened position in response to hydrodynamic force,
plumbed in parallel to convey fluid flow,
for placement into a fluid conduit to achieve the fluid flow sensor function with;
a turndown ratio higher than the said fluid flow sensor alone would offer, and
at a pressure drop lower than the said fluid flow sensor alone would require.

5. The flow sensor assembly of claim 4 wherein the conduit is a pipe.

6. The flow sensor assembly of claim 4 used to measure fluid flow in a residential plumbing control system.

7. In a volumetric flow sensor assembly comprising:
a fluid flow sensor; and
a normally-closed valve displaceable to an opened position in response to hydrodynamic force,
plumbed in parallel to convey fluid flow,
for placement into a fluid conduit,
the relationship that equates the said flow sensor frequency output to the fluid volumetric flow rate that flows through the said flow sensor assembly as, or equivalent to, the relationship,
pulses/volume=K-factor/(1+((Cv₂/Cv₁)²−((Cv₂)²(P_{cracking})(K-factor)²/(frequency output)²))^{0.5})
where:
pulses/volume is the number of pulses transmitted by the sensor in response to the fluid volume that has passed through said flow sensor assembly,
K-factor is the number of pulses transmitted by the sensor in response to the fluid volume that has passed through said flow sensor,
Cv₁ is the flow coefficient of flow through the flow sensor section of the flow sensor assembly,
Cv₂ is the flow coefficient of flow through the flow sensor assembly section containing a normally-closed valve displaceable to an opened position in response to hydrodynamic force,
P_{cracking} is the pressure drop at which flow commences through the said normally-closed, valve displaceable to an opened position, of the flow sensor assembly.

8. The relationship of claim 7 used to measure fluid flow in a residential plumbing control system.

9. In a volumetric flow sensor assembly comprising:
a fluid flow sensor; and
a normally-closed valve displaceable to an opened position in response to hydrodynamic force,
plumbed in parallel to convey fluid flow,
for placement into a fluid conduit,
the calibration relationship that equates the said flow sensor frequency output to the fluid volumetric flow rate that flows through the said flow sensor assembly as, or equivalent to, the relationship,
pulses/volume=K-factor/(1+((Cv₂/Cv₁)²−((Cv₂)² (P_{cracking})(K-factor)²/(frequency output)²))^{0.5})
where:
pulses/volume is the number of pulses transmitted by the sensor in response to the fluid volume that has passed through said flow sensor assembly,
K-factor is the number of pulses transmitted by the sensor in response to the fluid volume that has passed through said flow sensor,
Cv₁ is the flow coefficient of flow through the flow sensor section of the flow sensor assembly,
Cv₂ is the flow coefficient of flow through the flow sensor assembly section containing a normally-closed valve displaceable to an opened position in response to hydrodynamic force,
P_{cracking} is the pressure drop at which flow commences through the said normally-closed, valve displaceable to an opened position, of the flow sensor assembly.

10. The calibration relationship of claim 9 used to measure fluid flow in a residential plumbing control system.
